(19) United States
(12) Patent Application Publication
(10) Pub. No.: US 2020/0085225 A1
(43) Pub. Date: Mar. 19, 2020

(54) COOKER AND COOKING APPLIANCE HAVING SAME

(71) Applicant: LG ELECTRONICS INC., Seoul (KR)

(72) Inventors: Wansoo KIM, Seoul (KR); Yangkyeong KIM, Seoul (KR)

(21) Appl. No.: 16/461,073

(22) PCT Filed: Jun. 9, 2017
(86) PCT No.: PCT/KR2017/006016

§ 371 Date: May 15, 2019

(30) Foreign Application Priority Data
Nov. 15, 2016 (KR) 10-2016-0152272

(51) Int. Cl. A47J 27/088; F24C 7/06; H05B 6/06; H05B 6/12

(52) U.S. Cl. CPC A47J 27/088; F24C 7/06; H05B 2213/06; H05B 6/1236; H05B 6/1245; H05B 6/06

(57) ABSTRACT

The present embodiment relates to a cooker to be put on an induction heater having a working coil, the cooker comprising: a base; a container disposed at an upper part of the base and heated by an induced current of the working coil; a cap for covering the upper surface of the container; a pressure adjusting valve installed at the cap; a cooker communication module for communicating with the induction heater; and a cooker micro-computer for controlling the pressure adjusting valve and the cooker communication module. Therefore, the cooker enables cooking while the cooker is put on one selected from among multiple induction heaters having a working coil, thus improving the convenience of use, and is structurally simpler than a pressure rice cooker, thus minimizing the number of components thereof.

### CROSS-REFERENCE TO RELATED APPLICATIONS

This application is a National Stage application under 35 U.S.C. § 371 of International Application No. PCT/KR2017/006016, filed on Jun. 9, 2017, which claims the benefit of Korean Patent Application No. 10-2016-0152272, filed on Nov. 15, 2016. The disclosures of the prior applications are incorporated by reference in their entirety.

### TECHNICAL FIELD

The present invention relates to a cooker and a cooking appliance having the same, and more particularly, to a cooker making communication with an induction heater and a cooking appliance having the same.

### BACKGROUND ART

In general, a cooker that performs cooking using electricity is operated as a heater is provided inside a body.

Schemes of operating the heater of the cooker are classified into a scheme of using Joule's heat of resistance heating and an induction heating scheme in which a high frequency current of several tens of kilohertz (kHz) is applied to a coil to generate magnetic flux lines around the coil, and self-heating of a conductive object is caused due to the eddy current loss of the conductive object caused by the generated magnetic flux lines.

### DISCLOSURE

### Technical Problem

The present invention is to provide a cooker and a cooking apparatus having the same, which can be placed on an induction heater to perform cooking, can be simplified in structure, and can be implemented in a compact structure.

### Technical Solution

According to an embodiment of the present invention, a cooker may be placed on an induction heater having a working coil. In addition, according to an embodiment of the present invention, a cooking appliance may include a cooker, and an induction heater having a working coil to generate an induced current and a top plate on which the cooker is placed.

The cooker includes: a base; a container disposed on the base and heated by an induced current of the working coil; a cover to cover a top surface of the container; a pressure regulating valve provided in the cover; a cooker communication module to make communication with the induction heater; and a cooker microcomputer to control the pressure regulating valve and the cooker communication module.

The cooker may include a reception coil provided in the base to receive the induced current of the working coil; and a power converter to convert the induced current received in the reception coil into a direct current (DC).

The base may have an internal space to receive the reception coil therein.

The cooker may further include a heater disposed to surround a part of an outer circumferential surface of the container. The cooker microcomputer may include the DC of the power converter to the heater.

The cooker may further include a connector to connect the base with the cover, and the cooker microcomputer, the cooker communication module, and the power converter may be provided in the connector.

The connector may include, for example, a connector body positioned on the base; and a protrusion body protruding from the connector body, and an electric appliance receiving chamber may be formed in the protrusion body. The cooker microcomputer, the cooker communication module, and the power converter may be received in the electric appliance receiving chamber.

The connector body may include a protrusion portion protruding upward and a recess portion recessed downward, the protrusion portion and the recess portion being formed alternately along an outer circumferential surface of the container.

The connector may include, as another example, a first connector formed on the base and having an electric appliance receiving chamber inside the first connector; and a second connector extending from the first connector and spaced apart from the base in a vertical direction, the cover being disposed in the second connector to be lifted, and

The cooker microcomputer, the cooker communication module, and the power converter may be received in the electric appliance receiving chamber.

The cooker may further include a lifter to lift the cover. The lifter may include a lever protruding outward of the connector and at least one power transmission member to lift the cover while operating together with the lever when the lever is manipulated.

The connector may be formed therein with a lever guide hole to guide the lever to be lifted.

The cooker may further include a battery connected with the cooker microcomputer.

The cooker may further include a connector to connect the base with the cover, and the cooker microcomputer, the cooker communication module, and the battery may be provided in the connector.

The cooker may further include a temperature sensor provided in the base, and the cooker microcomputer may transmit temperature data, which is sensed by the temperature sensor, to the induction heater through the cooker communication module.

A temperature sensor receiving portion may be provided in a form of being recessed in the base or formed through the base to receive the temperature sensor.

The cooker microcomputer may receive a pressure regulating valve controlling signal, which is transmitted to the cooker communication module from the induction heater, to control an operation of the pressure regulating valve.

The induction heater may include an induction heater communication module to make communication with the cooker communication module; and an induction heater microcomputer to control the working coil and the induction heater communication module.

The induction heater microcomputer transmits a pressure regulating valve controlling signal, which is to control the pressure regulating valve, through the induction heater communication module.

The induction heater microcomputer may control the working coil based on the temperature data received through the induction heater communication module.

### Advantageous Effects

According to an embodiment, cooking is possible in the state that the cooker is placed on one of a plurality of induction heaters having a working coil, thereby increasing the use convenience. In addition, a simpler structure is provided and the number of parts is minimized as compared to those of a pressure cooker.

In addition, necessary power may be supplied to the temperature sensor, the pressure regulating valve, the cooker communication module, and the heater without the separate power cable.

In addition, the cooker may make communication with the induction heater, and the optimal control is possible with respect to the pressure regulating valve of the cooker or the working coil of the induction heater.

In addition, the electric appliance, such as the cooker microcomputer, the cooker communication module, the power converter, the battery, or the like may be protected.

### DESCRIPTION OF DRAWINGS

FIG. 1 is a perspective view illustrating a cooker and a cooking appliance having the same according to an embodiment of the present invention.

FIG. 2 is a perspective view of the cooker when the container illustrated in FIG. 1 is open.

FIG. 3 is a cutaway sectional view of a portion of the cooker according to an embodiment of the present invention.

FIG. 4 is a block diagram for controlling the cooking appliance, according to an embodiment of the present invention.

FIG. 5 is a perspective view illustrating a cooker and a cooking appliance having the same according to another embodiment of the present invention.

FIG. 6 is a perspective view of the cooker when a container illustrated in FIG. 5 is open.

FIG. 7 is a cutaway sectional view of a portion of the cooker according to another embodiment of the present invention.

### BEST MODE

### Mode for Invention

Hereinafter, the detailed embodiment of the present invention will be described in detail with reference to accompanying drawings.

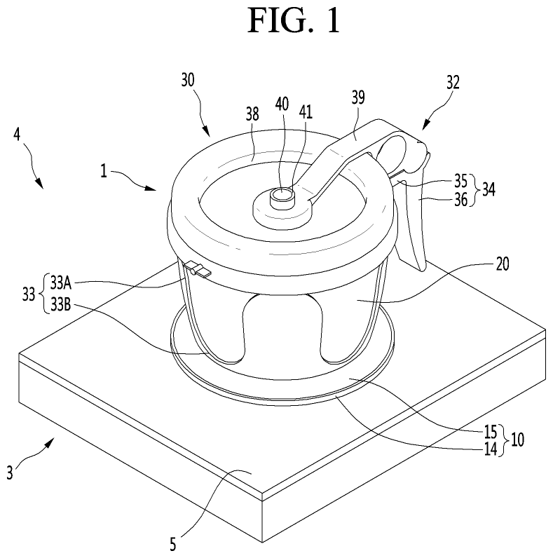

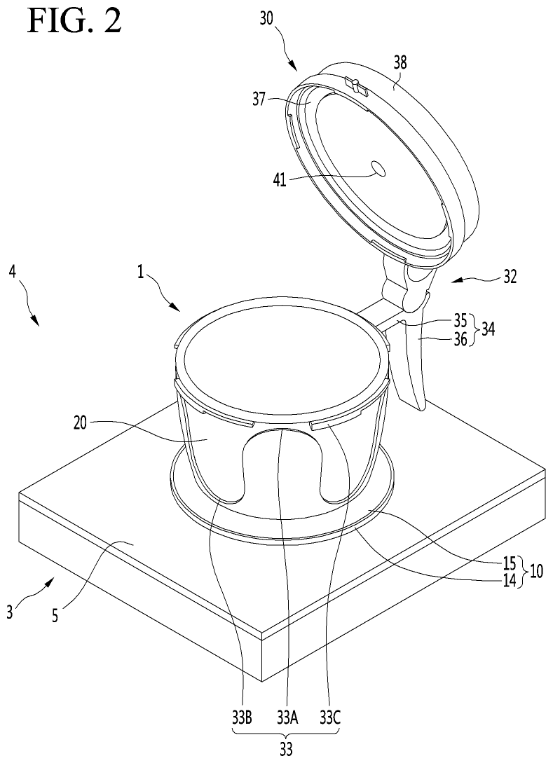

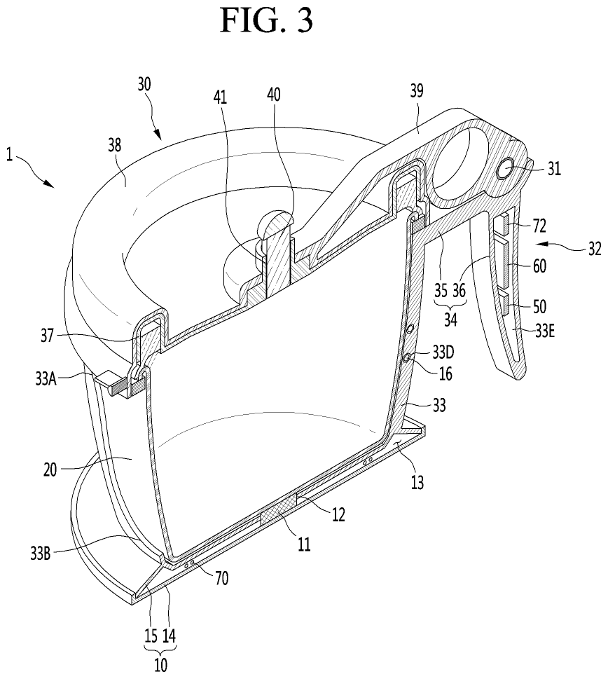

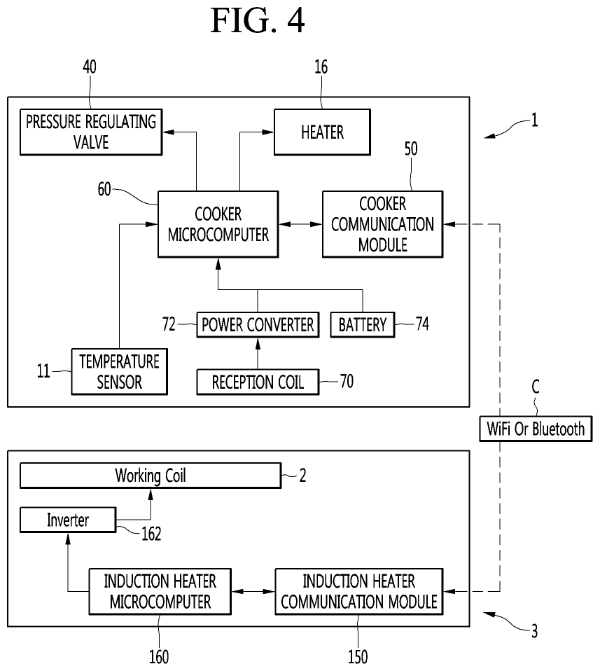

FIG. 1 is a perspective view illustrating a cooker and a cooking appliance having the same according to an embodiment of the present invention, FIG. 2 is a perspective view of the cooker when the container illustrated in FIG. 1 is open, FIG. 3 is a cutaway sectional view of a portion of the cooker according to an embodiment of the present invention, and FIG. 4 is a block diagram for controlling the cooking appliance, according to an embodiment of the present invention.

According to the present embodiment, a cooker 1 may be placed on an induction heater 3 having a working coil 2 and may be used. In this case, the induction heater 3 may be an IH cook top or an IH module to heat a container 20 through an induced current of the working coil 2.

The cooker 1 may constitute a cooking appliance 4 to cook foods in the cooker 1, together with the induction heater 3.

The induction heater 3 may include a top plate 5 on which the cooker 1 is placed, and the working coil 2 may generate the induced current inside the induction heater 3.

The cooker 1 may include: a base 10; the container 20 disposed on the base 10 and heated by an induced current of the working coil 2; a cover 30 to cover a top surface of the container 20; a pressure regulating valve 40 provided in the cover 3; a cooker communication module 50 to make communication with the induction heater 3; and a cooker microcomputer 60 to control the pressure regulating valve 40 and the cooker communication module 50.

The cooker 1 may further include a temperature sensor 11 provided in the base 10.

The temperature sensor 11 may measure the temperature of the container 20. The temperature sensor 11 may be provided to make contact with the container 20, especially, the bottom surface of the container 20, when the container 20 is seated on the base 10.

The base 10 may be formed therein with a temperature sensor receiving portion 12 to receive the temperature sensor 11.

The temperature sensor receiving portion 12 may be formed in a form of being recessed in the top surface of the base 10 or formed through the base 10. At least a portion of the temperature sensor 11 may be inserted into the temperature sensor receiving portion 12.

The temperature sensor 11 may be provided in a connector 32 to be described later. In this case, the temperature sensor receiving portion 12 to receive the temperature sensor 11 may be formed in the connector 32.

In this case, the cooker 1 is not limited to the feature that the temperature sensor 11 makes direct contact with the container 20, but may have the feature that a separate heat conduction portion (not illustrated) to transfer heat of the container 20 to the temperature sensor 11 is interposed between the container 20 and the temperature sensor 11.

The temperature sensor 11 may be connected with the cooker microcomputer 60 through a cable, especially, a temperature sensor cable.

The base 10 preferably includes a non-magnetic material which is not heated by the induced current generated by the working coil 2. In addition, the base 10 may make contact with the container 20, and may preferably include a material representing thermal conductivity lower than that of the container 20 to prevent heat of the container 20 from being transferred as much as possible.

The base 20 may include a non-magnetic material having thermal conductivity lower than that of the material of the container 20. If the container 20 includes stainless steel, the base 20 may include a synthetic resin such as plastic or non-magnetic metal representing thermal conductivity lower than that of the stainless steel.

The base 10 has a space 13 therein.

The base 10 may include a lower base 14 to form an outer appearance of the bottom surface of the cooker 1 and an upper base 15 disposed on the lower base 14.

The space 13 may be formed between the lower base 14 and the upper base 15. The space 13 of the base 10 may be a space in which a reception coil 70 to be described below or a battery 74 is received.

The container 1 may further include a heater 16 disposed to surround at least a part of an outer circumferential surface of the container 20.

The heater 16 may be provided at a portion to surround the outer circumferential surface of the container 20 of the cooker 1. The heater 16 may be provided in the connector 32 to be described below. The heater 16 may heat the container 20 by emitting heat in the state that the heater 16 is provided in the connector 32.

The heater 16 may be connected with the cooker microcomputer 60 through a cable, especially, a heater cable.

The container 20 may be heated through electromagnetic induction when a high-frequency current is applied to the working coil 2.

The container 20 may include a magnetic substance to emit heat by magnetic flux lines as the magnetic flux lines are generated by the induced current generated from the working coil 2. For example, the container 20 may include stainless steel.

The container 20 may have a top surface which is open. The container 20 may be seated on the top surface of the base 10.

A cover 30 may be provided to be larger than the upper end of the container 20, and may be seated on the upper end of the container 20 to seal the inner portion of the container 20.

The cooker 1 may further include the connector 32 to connect the base 10 to the cover 30.

The cover 30 may be rotatably coupled to the connector 32. The cover 30 may rotate about a hinge shaft 31 as the hinge shaft 31 is coupled to the cover 32.

The connector 32 may be integrated with the base 10. In addition, the connector 32 may be provided separately from the base 10 and may be coupled to the base 10 by a coupling member, such as a screw, or a locking portion such as a hook.

The connector 32 may include a connector body 33 positioned on the base 10, and a protrusion body 34 protruding from the connector body 33.

The connector body 33 may make contact with the container 20 in at least a portion therein, and may serve as a container supporter to support the container.

The protrusion body 34 may include a first protrusion body 35 protruding from the connector body 33 and a second protrusion body 36 protruding from the first protruding body 35 and spaced apart from the connector body 33.

The connector body 33 may be formed to surround a part of the outer circumferential surface of the container 20. In the connector body 33, a protrusion portion 33A protruding substantially upward and a recess portion 33B recessed substantially downward are formed alternately along the outer circumferential surface of the container 20. The connector body 33 may include an upper ring portion 33C connecting a plurality of protrusion portions 33A with each other.

Meanwhile, the connector 32 may include a heater installation portion 33D for installing the heater 14. The heater installation portion 33D may be formed on a face, which faces the outer circumferential surface of the container 20, of the connector 32. The heater installation portion 33D may be formed in the connector body 33. The heater installation portion 33D may be formed on a face, which faces the outer circumferential surface of the container 20, of the connector body 33.

The cover 30 may include the assembly of a plurality of members. The cover 30 may include an inner cover 37 facing an inner portion of the container 20 and an outer cover 38 to cover a top surface of the inner cover 37 and an outer circumferential surface of the inner cover 37, when covering the top surface of the container 20.

The cover 30 further include a lever 39 coupled to the outer cover 38 and coupled to the hinge shaft 31. The lever 39 may have the form of being bent at least one time or the form of being rounded. The lever 39 may has a cable receiving portion (not illustrated) in which a pressure regulating valve cable (not illustrated) is received to connect the pressure regulating valve 40 with the cooker microcomputer 60.

The cover 30 may be formed therein with a pressure regulating valve installation hole 41 in which the pressure regulating valve 40 is provided. The pressure regulating valve installation hole 41 may be positioned in an upper portion of the cover 20 when the cover 30 is covered. The pressure regulating valve installation hole 41 may be formed in at least one of the inner cover 37 or the outer cover 38.

The pressure regulating valve 40 may be provided in the cover 30 to regulate the internal pressure of the container 20. The pressure regulating valve 40 may be connected with the cooker microcomputer 60 through the pressure regulating valve cable and may be controlled by the cooker microcomputer 60.

The pressure regulating valve 40 may include a solenoid valve, and the solenoid valve may be switched on or off by the cooker microcomputer 60. When the solenoid valve is switched on, the internal fluid passage of the solenoid valve may be open, and, when the solenoid valve is switched off, the internal fluid passage of the solenoid valve may be closed.

The pressure regulating valve 40 may include an opening degree regulating valve to regulate the internal opening degree thereof.

The cooker communication module 50 may include a wired communication module to make wired communication with the induction heater 3 or may include a wireless communication module to make wireless communication C with the induction heater 3.

The cooker 1 may be used by being spaced apart from the induction heater 3 and the cooker communication module 50 may include a wireless communication module, such as a Wi-Fi module or Bluetooth module, to make wireless communication with the induction heater 3.

The cooker communication module 50 may make communication with an induction heater communication module 150, which is to be described later, of the induction heater 3, and the cooker 1 and the induction heater 3 may exchange various signals, such as temperature data or a pressure regulating valve controlling signal, together through the cooker communication module 50 and the induction heater communication module 150.

The cooker communication module 50 may be provided in the base 10 or the connector 32.

The cooker 1 may further include a reception coil 70 provided in the base 10 to receive the induced current of the working coil 2; and a power converter 72 to convert the induced current received in the reception coil 70 into a direct current (DC).

The reception coil 70 may be received in the space 13 of the base 10. The reception coil 70 may be spaced apart from the working coil 2 while interposing a portion of the base 10 and the top place 5 of the induction heater 3.

At least a portion of the reception coil 70 may be positioned above the working coil 2 in a vertical direction and the reception coil 70 may receive a portion of the induced current generated from the working coil 2.

When the cooker 1 includes all the reception coil 70 and the power converter 72, the cooker microcomputer 60 may apply a direct current (DC) of the power converter 72 to various appliances, for example, at least one of the pressure regulating valve 40, the cooker communication module 50, the temperature sensor 11, or the heater 16, constituting the cooker 1.

In this case, the cooker 1 may operate various electric appliances constituting the cooker 1 without a power cable to connect the induction heater 3 with the cooker 1 or a power cable connected with an outlet.

When the cooker 1 includes the reception coil 70 and the power converter 72, the power converter 72 may be provided in the base 10 or the connector 32, together with the cooker microcomputer 60 and the cooker communication module 50.

Meanwhile, as another example of the cooker 1, the cooker 1 may further include a battery 74 connected with the cooker microcomputer 60, instead of the reception coil 70 and the power converter 72.

As still another example of the cooker 1, the cooker 1 may further include the battery 74 in addition to the reception coil 70 and the power converter 72.

When the cooker 1 includes the battery 74, the cooker microcomputer 60 may apply a DC of the battery 74 to various appliances, for example, at least one of the pressure regulating valve 40, the cooker communication module 50, the temperature sensor 11, or the heater 16, constituting the cooker 1.

In this case, the cooker 1 may operate various electric appliances constituting the cooker 1 without a power cable to connect the induction heater 3 with the cooker 1 or a power cable connected with an outlet.

The battery 74 may be provided in the base 10 or the connector 32, together with the cooker microcomputer 60 and the cooker communication module 50.

The cooker microcomputer 60 may be provided in the base 10 or the connector 32.

The base 10 or the connector 32 may have an electric appliance receiving chamber 33E to receive at least one of the cooker microcomputer 60, the cooker communication module 50, the power converter 72, or the battery 70. The electric appliance receiving chamber 33E may be preferably provided at a position spaced apart from the container 20 as much as possible. The electric appliance receiving chamber 33E may be provided in a part, which is spaced apart from the container 20, of the connector 32. Preferably, the electric appliance receiving chamber 33E is formed in the protrusion body 34. The electric appliance receiving chamber 33E may be formed in the second protrusion body 36 spaced apart from the connector body 33.

The cooker microcomputer 60 may transmit temperature data, which is sensed by the temperature sensor 11, to the outside of the cooker 1 through the cooker communication module 50. The cooker 1 may transmit the temperature data to the induction heater 3 through the cooker communication module 50, and the induction heater 3 may control the working coil 2 based on the temperature data received through the cooker communication module 50.

The cooker microcomputer 60 may apply the power of the power converter 72 or the battery 74 to the heater 16 when foods are cooked by the cooker 1, and the heater 16 may emit heat to heat the container 20. The cooker microcomputer 60 may apply power to the heater 16 based on the temperature data sensed by the temperature sensor 11.

When the pressure regulating valve controlling signal is received through the cooker communication module 50, the cooker microcomputer 60 may control the operation of the pressure regulating valve 40 in response to the pressure regulating valve controlling signal.

When an on signal is input through the cooker communication module 50 to open the pressure regulating valve 40, the cooker microcomputer 60 may output the on signal to the pressure regulating valve 40, and the pressure regulating valve 40 may open the internal fluid passage thereof.

When an opening degree increasing signal is input through the cooker communication module 50 to increase the opening degree of the pressure regulating valve 40 by a predetermined degree, the cooker microcomputer 60 may output the opening degree increasing signal to the pressure regulating valve 40 and the pressure regulating valve 40 may increase the opening degree by a set degree in response to the opening degree increasing signal.

The induction heater 3 may include; the induction heater communication module 150 to make communication with the cooker communication module 50; and an induction heater microcomputer to control the working coil 2 and the induction heater communication module 150. The induction heater 3 may further include an inverter 164 connected with the working coil 2 and the induction heater microcomputer 160.

The induction heater communication module 150 may include a wireless communication module, such as a Wi-Fi module or a Bluetooth module, to make wireless communication with the cooker communication module 50 of the cooker 1.

The induction heater microcomputer 160 may control the frequency input to the working coil 2 based on the temperature data received through the cooker communication module 50 and the induction heater communication module 150.

The induction heater microcomputer 160 may generate the pressure regulating valve controlling signal to control the pressure regulating valve 40 based on the temperature data or a preset program received through the cooker communication module 50 and the induction heater communication module 150 and may transmit the pressure regulating valve controlling signal through the induction heater communication module 150.

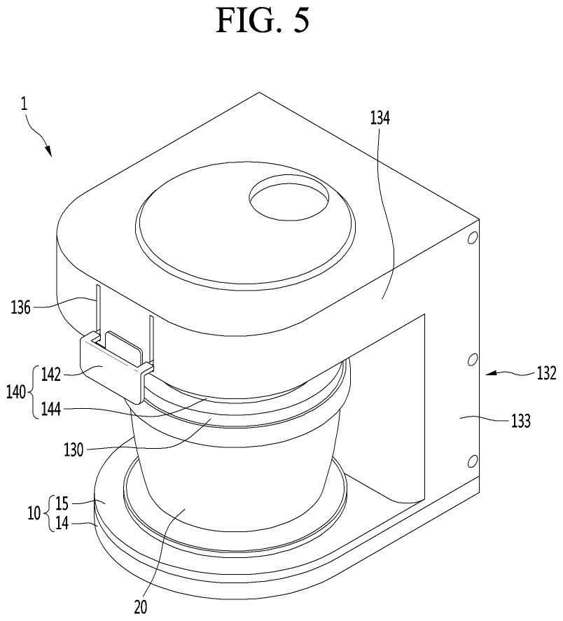

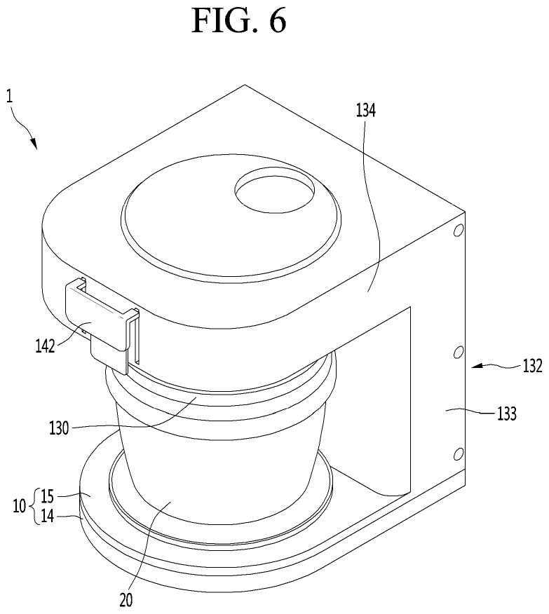

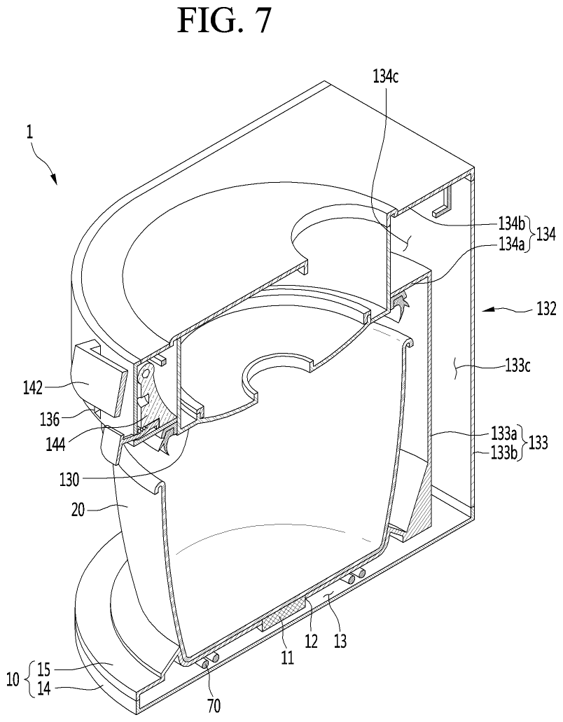

FIG. 5 is a perspective view illustrating a cooker and a cooking appliance having the same according to another embodiment of the present invention, FIG. 6 is a perspective view of the cooker when a container illustrated in FIG. 5 is open, and FIG. 7 is a cutaway sectional view of a portion of the cooker according to another embodiment of the present invention.

According to the present embodiment, a cover 130 is different from the cover 30 according to an embodiment of the present invention, a connector 132 is different from the connector 32 according to an embodiment of the present invention, and other components and operations are the same as or similar to those according to an embodiment of the present invention except for the cover 130 and the connector 132. Accordingly, the same reference numerals will be assigned to the other components and the operations, and the details thereof will be omitted.

According to the present invention, the connector 132 may be formed in the substantially inverted-L shape on the base 10. The connector 132 includes a first connector 133 formed on the base 10 in a vertical direction and having an internal space; and a second connector 134 extending from the first connector 133 and spaced apart from the base 10 in the vertical direction.

The first connector 133 has an internal space therein. The first connector 133 may include a pair of first walls 133a and 133b disposed on the base 10 to be spaced apart from each other in a horizontal direction, and a first space 133c may be interposed between the pair of first walls 133a and 133b. The first space 133c may be an electric appliance receiving chamber to be described below.

The second connector 134 has an internal space therein. The second connector 134 may include a pair of second walls 134a and 134b disposed on the first connector 133 to be spaced apart from each other in the vertical direction, and a second space 134c may be interposed between the pair of second walls 134a and 134b. The second space 134c may be a cover receiving chamber to be described below.

The connector 132 may be formed therein with the electric appliance receiving chamber to receive at least one of the cooker microcomputer 60, the cooker communication module 50, the power converter 72, or the battery 74, similarly to those according to an embodiment of the present invention. The electric appliance receiving chamber may be formed inside the first connector 133. At least one of the cooker microcomputer 60, the cooker communication module 50, the power converter 72, or the battery 74 may be received between the pair of first walls 133a and 133b.

The cover receiving chamber may be formed inside the connector 132 to receive the cover 130 such that the cover 130 is lifted. The cover receiving chamber may be formed inside the second connector 134. The cover 130 may be received between the pair of second walls 134a and 134b.

The cover 130 may be disposed in the connector 132 to be lifted. The cover 130 may be disposed in the second connector 134, which is spaced apart from the base 10 in the vertical direction, to be lifted. At least a portion of the cover 130 may be disposed to be received in the second space 134c of the second connector 134.

The cover 130 is moved down in the connector 132 to make contact with an upper end of the container 20 while covering the top surface of the container 20, and is moved up from the upper end of the container 20 to be spaced apart from the upper end of the container 20 to open the top surface of the container 20.

A lifter 140 may be provided in the connector 132 to lift the cover 130. The lifter 140 may include a lever 142 provided to protrude outward of the connector 132 and at least one power transmission member 144 to lift the cover 130 while operating together with the lever when the lever is manipulated.

The lever 142 may be disposed in the connector 132 to be lifted. The connector 132 is formed therein with a lever guide hole 136 to guide the lever 142 to be lifted.

Hereinabove, although the present invention has been described with reference to exemplary embodiments and the accompanying drawings, the present invention is not limited thereto, but may be variously modified and altered by those skilled in the art to which the present disclosure pertains without departing from the spirit and scope of the present invention claimed in the following claims.

Therefore, embodiments of the present invention are not intended to limit the technical spirit of the present disclosure, but provided only for the illustrative purpose.

The scope of protection of the present invention should be construed by the attached claims, and all equivalents thereof should be construed as being included within the scope of the present disclosure.

1. A cooker placed on an induction heater having a working coil, the cooker comprising:
a base;
a container disposed on the base and heated by an induced current of the working coil;
a cover to cover a top surface of the container;
a pressure regulating valve provided in the cover;
a cooker communication module to make communication with the induction heater; and
a cooker microcomputer to control the pressure regulating valve and the cooker communication module.

2. The cooker of claim 1, further comprising:
a reception coil provided in the base to receive the induced current of the working coil; and
a power converter to convert the induced current received in the reception coil into a direct current (DC).

3. The cooker of claim 2, wherein the base has an internal space to receive the reception coil therein.

4. The cooker of claim 2, further comprising:
a heater disposed to surround a part of an outer circumferential surface of the container;
wherein the cooker microcomputer applies the DC of the power converter to the heater.

5. The cooker of claim 2, further comprising:
a connector to connect the base with the cover,
wherein the cooker microcomputer, the cooker communication module, and the power converter are provided in the connector.

6. The cooker of claim 5, wherein the connector includes:
a connector body positioned on the base; and
a protrusion body protruding from the connector body,
wherein an electric appliance receiving chamber is formed in the protrusion body, and
wherein the cooker microcomputer, the cooker communication module, and the power converter are received in the electric appliance receiving chamber.

7. The cooker of claim 6, wherein the connector body includes a protrusion portion protruding upward and a recess portion recessed downward, the protrusion portion and the recess portion being formed alternately along an outer circumferential surface of the container.

8. The cooker of claim 5, wherein the connector includes:
a first connector formed on the base and having an electric appliance receiving chamber inside the first connector; and
a second connector extending from the first connector and spaced apart from the base in a vertical direction, the cover being disposed in the second connector to be lifted, and
wherein the cooker microcomputer, the cooker communication module, and the power converter are received in the electric appliance receiving chamber.

9. The cooker of claim 8, further comprising:
a lifter to lift the cover,
wherein the lifter includes a lever protruding outward of the connector and at least one power transmission member to lift the cover while operating together with the lever when the lever is manipulated.

10. The cooker of claim 9, wherein the connector is formed therein with a lever guide hole to guide the lever to be lifted.

11. The cooker of claim 1, further comprising:
a battery connected with the cooker microcomputer.

12. The cooker of claim 11, further comprising:
a connector to connect the base with the cover,
wherein the cooker microcomputer, the cooker communication module, and the battery are provided in the connector.

13. The cooker of claim 1, further comprising:
a temperature sensor provided in the base,
wherein the cooker microcomputer transmits temperature data, which is sensed by the temperature sensor, to the induction heater through the cooker communication module.

14. The cooker of claim 13, wherein a temperature sensor receiving portion is provided in a form of being recessed in the base or formed through the base to receive the temperature sensor.

15. The cooker of claim 11, wherein the cooker microcomputer receives a pressure regulating valve controlling signal, which is transmitted to the cooker communication module from the induction heater, to control an operation of the pressure regulating valve.

16. A cooking appliance comprising;
a cooker; and
an induction heater having a working coil to generate an induced current and a top plate on which the cooker is placed,
wherein the cooker includes:
a base;
a temperature sensor provided in the base;
a container disposed on the base and heated by the induced current of the working coil;
a cover to cover a top surface of the container;
a pressure regulating valve mounted in the cover;
a cooker communication module;
a cooker microcomputer to control the pressure regulating valve and the cooker communication module;
a reception coil provided in the base to receive the induced current of the working coil; and
a power converter to convert the induced current received in the reception coil into a direct current (DC),
wherein the induction heater includes:
an induction heater communication module to make communication with the cooker communication module; and
an induction heater microcomputer to control the working coil and the induction heater communication module,
wherein the cooker microcomputer transmits temperature data, which is sensed by the temperature sensor, through the cooker communication module, and
wherein the induction heater microcomputer transmits a pressure regulating valve controlling signal, which is to control the pressure regulating valve, through the induction heater communication module.

17. The cooking appliance of claim 16, wherein the cooker microcomputer controls an operation of the pressure regulating valve, when receiving the pressure regulating valve controlling signal through the cooker communication module.

18. The cooking appliance of claim 16, wherein the induction heater microcomputer controls the working coil based on the temperature data received through the induction heater communication module.

19. The cooking appliance of claim 16, wherein the cooker further includes:
a heater disposed to surround a part of an outer circumferential surface of the container, and
wherein the cooker microcomputer applies a DC of the power convert to the heater.

20. The cooking appliance of claim 16, wherein the cooker further includes:
a connector to connect the base with the cover, and
wherein the cooker microcomputer, the cooker communication module, and the power converter are provided in the connector.
